(19) United States
(12) Patent Application Publication
(10) Pub. No.: US 2017/0373459 A1
(43) Pub. Date: Dec. 28, 2017

(54) VOLUME POLARIZATION GRATING, METHODS OF MAKING, AND APPLICATIONS

(71) Applicant: UNIVERSITY OF CENTRAL FLORIDA RESEARCH FOUNDATION, INC., Orlando, FL (US)

(72) Inventors: Yishi Weng, Orlando, FL (US); Daming Xu, Orlando, FL (US); Shin-Tson Wu, Orlando, FL (US)

(73) Assignee: UNIVERSITY OF CENTRAL FLORIDA RESEARCH FOUNDATION, INC., Orlando, FL (US)

(21) Appl. No.: 15/631,312

(22) Filed: Jun. 23, 2017

Related U.S. Application Data
(60) Provisional application No. 62/354,956, filed on Jun. 27, 2016.

(51) Int. Cl. H01S 3/08; G03H 1/02; G02B 5/18; G02B 5/20; G11B 7/0065; G02B 6/293; G02B 6/12

(52) U.S. Cl. CPC H01S 3/08009; G11B 7/0065; G03H 1/0248; G02B 6/29397; G02B 6/29373; G02B 5/1857; G02B 6/29308; G02B 6/29311; G02B 5/203; G02B 6/12007

(57) ABSTRACT

A polarization volume grating (PVG) includes a bulk, birefringent medium characterized by a plurality of helical structures with helix axes and a periodicity Λ_{y} and an anisotropic alignment material having a rotatable optical axis, disposed on a top or bottom surface of the medium. The PVG is characterized in that the optical axis of the alignment material has a continuously rotated optical axis orientation in a plane of the material surface and a periodicity Λₓ, wherein the helix axes are normal to the optical axes in the alignment material surface, further wherein the birefringent medium is characterized by a plurality of controllably slanted refractive index planes having a slant angle φ=±arctan (Λ_{y}/Λₓ) and a Bragg period Λ_{B}. Fabrication methods are disclosed.

### RELATED APPLICATION DATA

The instant application claims priority to U.S. provisional application Ser. 62/354,956 filed Jun. 27, 2016, the subject matter of which is incorporated by reference herein in its entirety.

### GOVERNMENT FUNDING

Funding for the invention was provided by the US Air Force Office of Scientific Research under award BAA-AFOSR-2013-0001. The government has certain rights in the invention.

### BACKGROUND

Aspects and embodiments of the invention are most generally directed to optical apparatus; more particularly to diffraction gratings; and, most particularly to a polarization volume grating (PVG), methods for making such a grating, and applications thereof.

Holographic volume gratings (HVGs) have been widely used in a variety of applications as a unique diffractive element for beam steering. A HVG is formed based on the interference pattern in a bulk hologram recording material such as photopolymer or photorefractive glass. The most distinctive feature of a HVG is that when it is illuminated by a Bragg-matched beam, a highly efficient diffraction in only one order can be generated based on the Bragg diffraction, and the diffraction angle can be quite large. Meanwhile, a HVG has high transmittance due to its narrow diffraction bandwidth and high angular selectivity.

Another optical element known as diffractive waveplate (DW) (or polarization grating (PG) or optical axis grating (OAG)) has been reported. The DW is characterized by periodic variations in the orientation of the optical axis in an anisotropic medium. For a typical DW, the optical axis of the material is periodically rotating in the plane of the DW along one axis of a Cartesian coordinate system, which is termed a cycloidal diffractive waveplate (CDW). When the thickness of a CDW reaches a half-wave that phase retardation demands, it can present as a transmissive grating. Compared to the HVG, the unique feature of a CDW is its sensitivity to polarization; the +1^{st} or −1^{st} diffraction order can appear with high diffraction efficiency, respectively, depending on the handedness of incident circularly polarized light. However, the diffraction angle for a CDW is relatively small (˜15° in air) and it is difficult to enlarge due to the physical mechanism involved, which is much smaller than the diffraction angle of a HVG.

An improved CDW scheme for achieving achromatic diffraction has been reported that consists of two stacked antisymmetric chiral, circular DWs with an opposite twist sense; achromatic diffraction can be achieved by compensating the chromatic dispersion of retardation through the reversed twist structures.

The inventors have recognized the advantages and benefits of a polarization volume grating (PVG) that improves upon the features, performance, cost, and complexity of currently available apparatus and methods, and having broader utility to various applications.

### SUMMARY

An aspect of the invention is a polarization volume grating (PVG). In a non-limiting, exemplary embodiment the PVG includes a bulk, birefringent medium having a top surface and a bottom surface and characterized by a plurality of helical structures with helix axes and a periodicity Λ_{y}; an anisotropic alignment material having a rotatable optical axis, disposed on at least one of the top surface and the bottom surface of the medium, characterized in that the optical axis of the alignment material has a continuously rotated orientation in a plane of the alignment material surface and a periodicity A, wherein the helix axes are normal to the optical axes in the alignment material surface, wherein the bulk, birefringent medium is further characterized by a plurality of controllably slanted refractive index planes having a slant angle φ=±arctan (Λ_{y}/Λₓ) and a Bragg period Λ_{B}. In various non-limiting, alternative embodiments the PVG may have one or more of the listed features, components, limitations, characteristics, alone or in various combinations as one skilled in the art would understand, as follows:

wherein the plurality of controllably slanted refractive index planes has a gradient pitch length;
wherein the birefringent material is one of a liquid crystal (LC) and a reactive mesogen;
characterized by a periodically and continuously changing refractive index along two orthogonal directions that are parallel and normal to the alignment substrate;
comprising a reflection PVG;
comprising a transmission PVG.

In a non-limiting, exemplary embodiment the PVG includes a medium having a periodically and continuously changing refractive index along two orthogonal directions. In various non-limiting, alternative embodiments the PVG may have one or more of the listed features, components, limitations, characteristics, alone or in various combinations as one skilled in the art would understand, as follows:

wherein the medium has a top and a bottom surface and an intermediate bulk region, further wherein an optical axis along and in the plane of at least one of the top and bottom surfaces is characterized by a continuous, periodic directional change, further wherein the bulk medium region is characterized by a tilted, periodic refractive index distribution;
wherein the at least one of the top and bottom surface comprises a photo-alignment material;
wherein the at least one of the top and bottom surface comprises a linear photo-polymerizable polymer (LPP);
   wherein the bulk medium region comprises a birefringent material including a plurality of chiral-doped helical structures that are periodic along a helical axis of the chiral-doped medium normal to the top and bottom surfaces;
wherein the bulk medium region comprises a reactive mesogen or a liquid crystal (LC);
   wherein the bulk medium region is characterized by a tilted periodic refractive index distribution;
   wherein the bulk medium region is characterized by a tilted, gradient, periodic refractive index distribution.

An aspect of the invention is a method of making a PVG. In a non-limiting, exemplary embodiment, a method of making a PVG comprising a bulk, birefringent medium having a top surface and a bottom surface and characterized by a plurality of helical structures with helix axes and a periodicity Λ_{y}; an anisotropic alignment material having a rotatable optical axis, disposed on at least one of the top surface and the bottom surface of the medium, characterized in that the optical axis of the alignment material has a continuously rotated orientation in a plane of the alignment material surface and a periodicity A, wherein the helix axes are normal to the optical axes in the alignment material surface, wherein the bulk, birefringent medium is further characterized by a plurality of controllably slanted refractive index planes having a slant angle φ=±arctan (Λ_{y}/Λₓ) and a Bragg period Λ_{B}, wherein the alignment material having the periodically rotating optical axis is fabricated by one of photo-alignment or physical etching. In various non-limiting, alternative embodiments the method may have one or more of the listed steps, features, components, limitations, characteristics, alone or in various combinations as one skilled in the art would understand, as follows:

wherein said photo-alignment involves exposing reactive mesogens or other photo-anisotropic media using a beam with constant intensity and spatially varying polarization;
comprising one of holographic exposure or direct write;
   wherein holographic exposure uses two orthogonal circularly polarized beams, namely left- and right-handed circular polarized beams, that interfere with each other; and the reactive mesogens or other photo-anisotropic medium records an interference pattern;
      comprising adjusting the periodic length of the interference pattern by changing the angle between the two exposure beams;
   wherein the direct-write uses the approach of scanning or rotating techniques through projecting light beams with different linear polarization angles sequentially in space to generate the alignment patterns;
      comprising adjusting the helical pitch by controlling a helical twist power (HTP) or a concentration of a chiral dopant;
      comprising injecting the birefringent material in-between two substrates or spin coated onto the substrate.

### BRIEF DESCRIPTION OF THE FIGURES

FIG. 1: A schematic diagram of the PVG. The optical axis rotates in xz-plane; the rotating angle α changes continuously and periodically along x and y directions with period of Λₓ and Λ_{y}, respectively. The refractive index distribution presents as a tilted volume grating with a tilt angle φ. Bragg diffraction can be established when the medium is thick enough to generate sufficient periodical refractive index planes, according to an exemplary embodiment of the invention.

FIG. 2: Geometry and notation of diffraction orders for (a) reflective PVG and (b) transmissive PVG: θᵢ is the incident angle and θ_{diff} is the diffraction angle for the first-order. The 0^{th} order is the transmitted beam without diffraction, according to an illustrative embodiment of the invention.

FIG. 3: Schematically shows the surface alignment pattern as an interference pattern generated by two orthogonal circularly polarized beams, which can be recorded in a photoalignment material after exposure, according to an exemplary embodiment of the invention.

FIG. 4: Schematic diagram of the polarization states of diffraction order for (a) reflective and (b) transmissive PVGs when the normally incident beam is left-handed circularly polarized (LCP) and right-handed circularly polarized (RCP). The handedness of the helical twist in both reflective and transmissive PVGs is assumed to be left-handed along the incident direction, according to an illustrative embodiment of the invention.

FIG. 5: The simulated electric field distribution with different circularly polarized incident beams using COMSOL Multiphysics: (a) Left-handed circularly polarized light, and (b) right-handed circularly polarized light. Bragg reflection occurs when the incident beam has the same handedness as the twist helix in the reflective PVG (right-handed in simulation). In simulation, we assume birefringence Δn=0.2 (nₑ=1.7, nₒ=1.5), PVG thickness d=4 μm, refractive index of glass n_{glass}=1.57 and operation wavelength λ=550 nm. Small arrows represent the power flow or Poynting vector, according to an illustrative embodiment of the invention.

FIG. 6: (a) Diffraction efficiency spectra with different diffraction angles. The Bragg wavelength for all diffraction angles is 550 nm; (b) Diffraction efficiency as a function of d/p for different operation wavelengths. When d/p>7, diffraction efficiency over 98% can be achieved. The corresponding thickness required for the three specified diffraction angles (20°, 40°, 60° in glass (n=1.57)) is 2.52 μm, 2.8 μm and 3.29 μm when λ=550 nm, and 2.94 μm, 3.19 μm and 3.73 μm when λ=633 nm. In simulation, we assume Δn=0.2 (nₑ=1.7, nₒ=1.5).

FIG. 7: The effects of Δn on a reflective PVG: (a) Diffraction efficiency spectra; and (b) diffraction efficiency with different incident angles. In simulation, nₒ=1.5, d=4 μm and the diffraction angle is 60° at λ=550 nm.

FIG. 8: Simulated diffraction efficiency spectra of the reflective PVGs with uniform pitch and gradient pitch. For gradient pitch, two specific pitch ranges (p=340˜500 nm and p=300˜600 nm) are simulated. In simulation, we assumed birefringence Δn=0.3, nₒ=1.5, and the thickness of the reflective PVG is d=8 μm.

FIG. 9: Simulated far-field diffraction pattern for (a) CDW and (b) transmissive PVG. Two orthogonal circularly polarized beams at normal incidence (0°) were set as the incident light, respectively, according to an illustrative embodiment of the invention.

FIG. 10: (a) Relation between −1^{st} order diffraction efficiency and thickness for a transmissive PVG with different diffraction angles in air (Δn=0.2). A right-handed circularly polarized light with λ=550 nm was used as input; (b) The pitch length (or period length along the y-direction) requirement for different diffraction angles at d=1.37 μm.

FIG. 11: Diffraction behavior of a transmissive PVG for different diffraction angles in air: (a) diffraction efficiency spectra and (b) angular response for the −1^{st} order. In simulation, the input circularly polarized light has the same handedness as the optical axis rotation in PVG. The Bragg wavelength for all diffraction angles is 550 nm and LC Δn is 0.2.

FIG. 12: Δn effect of a transmissive PVG: (a) simulated diffraction efficiency spectra and (b) diffraction efficiency with different incident angles. In simulations, we assume nₒ=1.5, d=λ_{B}/(2Δn), and λ_{B}=550 nm.

FIG. 13: Simulated diffraction efficiency for different orders as a function of d/p. The input is a linearly polarized plane wave with λ=550 nm. The birefringence Δn is 0.2 and thickness d=λ/(2Δn)=1.37 μm. The values along the top indicate the corresponding diffraction angles of the 1^{st} order in air for some specific d/p ratios.

FIG. 14: Schematic rendering of a 2D/3D wearable display using planar waveguides with the reflective PVGs, according to an exemplary embodiment of the invention.

FIG. 15: Simulated results for two stacked PVGs used as an in-coupled grating in a wearable display device. A linear polarized incident beam was split into two orthogonal circular polarized beams with two diffracted angles.

### DETAILED DESCRIPTION OF NON-LIMITING, EXEMPLARY EMBODIMENTS

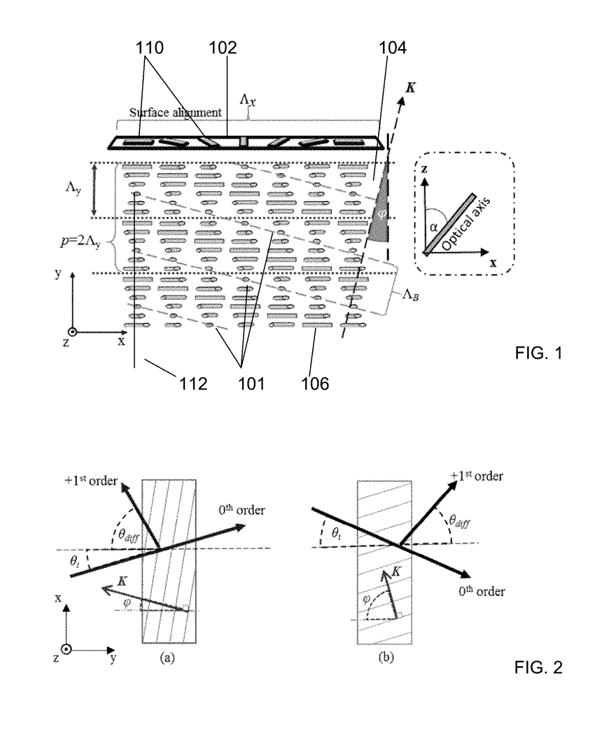

In the embodied PVG (in contrast to a typical CDW), the direction perpendicular to the surface is not homogenous. By adding a chiral dopant to a nematic host, the LC exhibits helical structures and provides another periodicity, Λ_{y} (in addition to Λₓ) perpendicular to the surface, which generates periodically slanted refractive index planes 101 as shown in FIG. 1. When the number or thickness of the periodic refractive index planes reaches a sufficient value, Bragg diffraction is observed based on the theory of volume gratings. Similarly to a cholesteric liquid crystal (CLC), the inventive embodiment is sensitive to the handedness of the incident circular polarization, but can steer the reflected beam without tilting the helical axis. As a result, a Polarization Volume Grating (PVG) as embodied herein can be generated. Such a grating offers combined advantages of a HVG and a CDW; i.e., high diffraction efficiency, large diffraction angles, and polarization selectivity. Similar to a HVG, both reflective and transmissive types of PVGs can be formed.

Herein below we describe the operation principles of a PVG in detail and build a rigorous FEM model to simulate and analyze the characteristics of both reflective and transmissive PVGs with commercial software COMSOL.

### Physical Principles

In a conventional CLC, a chiral dopant is added to induce helical twist along the vertical (y-axis) direction, whereas the LC is homogeneous in the horizontal (x-z) plane (referring to the coordinate system in FIG. 1). In contrast, in the embodied PVG we introduce one more periodicity in the horizontal plane, as illustrated in FIG. 1. The alignment material (substrate 102) is treated as described herein below to provide a rotation of the LC optical axis 110 in the xz-plane, and the rotating angle α changes continuously and periodically along the x-axis with a period of A. Beneath the alignment substrate 102, a bulk birefringent medium 104 (e.g., a LC or a reactive mesogen), exhibits helical structures 106 having helix axes 112 and a period length of Λ_{y} (or one half of the pitch lengthp) along the y-axis. Such a scheme generates a series of slanted and periodic refractive index planes 101 at slant angle φ=±arctan (Λ_{y}/Λₓ).

To simplify the disclosed analysis without losing its generality, we assume 0°<φ<90°.

In order to form the periodic surface alignment pattern 110 along the x-axis of the alignment substrate, various methods can be employed such as using photopolymers to record the interference patterns of left- and right-handed circular-polarized beams. The helical structures along the y-direction in the bulk birefringent media can also be easily achieved by doping a chiral dopant into the birefringent host, and the periodicity Λ_{y} (or pitch length p=2Λ_{y}) can be adjusted via controlling the helical twist power (HTP) and concentration of a chiral dopant. Since the Bragg reflection requires several periods to build up, the birefringent material needs to be thick enough for allowing several pitches to co-exist in the bulk, as one skilled in the art would understand.

Due to the helical twisting power of the chiral dopant, the LC directors (optical axes 110) will rotate along the helix axes 112. Unlike a conventional CLC, due to the periodic surface alignment pattern, the LC directors at different positions will rotate at different azimuthal angles in the xz-plane. However, if we observe the LC directors along an oblique direction, the LC optical axes with the same azimuthal angles are actually aligned at a tilted angle, φ, as shown by the dashed lines 101 in FIG. 1. The azimuthal angles of an optical axis with rotation a with different coordinates in a PVG are determined by the following equation:

α=(π/Λₓ)x+(π/Λ_{y})y (1)

wherein the period lengths Λₓ and Λ_{y} correspond to the optical axis rotation of π due to the equivalence between the optical rotations of mπ (m=0, 1, 2, 3) for a birefringent material. When the LC layer 104 is thick enough, Bragg diffraction can be established. As a result, the normally incident light would be diffracted. The Bragg diffraction is governed by:

2n_{eff}Λ_{B} cos φ=λ_{B} (2)

In Eq. (2), λ_{B} is the Bragg wavelength in vacuum, Λ_{B} is the Bragg period, φ is the slanted angle of the periodic refractive index planes (represented as the slanted angle of the grating vector K (see FIG. 1)), and n_{eff} is the effective refractive index of the birefringent medium defined by:

n_{eff}=(nₑ²+2nₒ²)/3. (3)

The Bragg period Λ_{B} has a simple geometric relationship with Λₓ and Λ_{y} as:

$$\{ \begin{matrix}{Λ}_{x} = {Λ}_{B} / sin ϕ \\ {Λ}_{y} = {Λ}_{B} / cos ϕ\end{matrix} . \qquad ( 4 )$$

Both reflective and transmissive PVGs can be fabricated depending on the direction of the incident and diffracted beams. For reflective gratings, the diffracted beam is on the same side of the grating as the incident beam as illustrated in FIG. 2(a). With transmissive gratings the incident and diffracted beams are on different sides of the grating as illustrated in FIG. 2 (b). When the incident angle θᵢ=0°, the PVG can be distinguished between the reflective and transmissive types simply by the range of the slanted angle φ. Based on the theory of volume gratings, the relationship between slanted angle φ and the first-order diffraction angle θ_{diff} when θᵢ=0° is given by:

$${θ}_{diff} = \{ \begin{matrix}2 ϕ & 0 \leq ϕ < \frac{π}{4} \\ π - 2 ϕ & \frac{π}{4} < ϕ < \frac{π}{2}\end{matrix} . \qquad ( 5 )$$

In Eq. (5), when 0<φ<π/4, the PVG works as a reflective grating, while at π/4<β<π/2 it functions as a transmissive grating.

To fabricate the surface alignment 110 with periodically (Λₓ) rotated optical axes, one method is to expose a reactive mesogen material 104 using a beam with constant intensity but spatially varying polarization. A reported technique utilized an LCD projector and rotatable waveplate to sequentially project light beams with different linear polarization angles. In this method, an x-direction periodicity of 80 μm was achieved, but the diffraction angle was only 0.453° due to the large period.

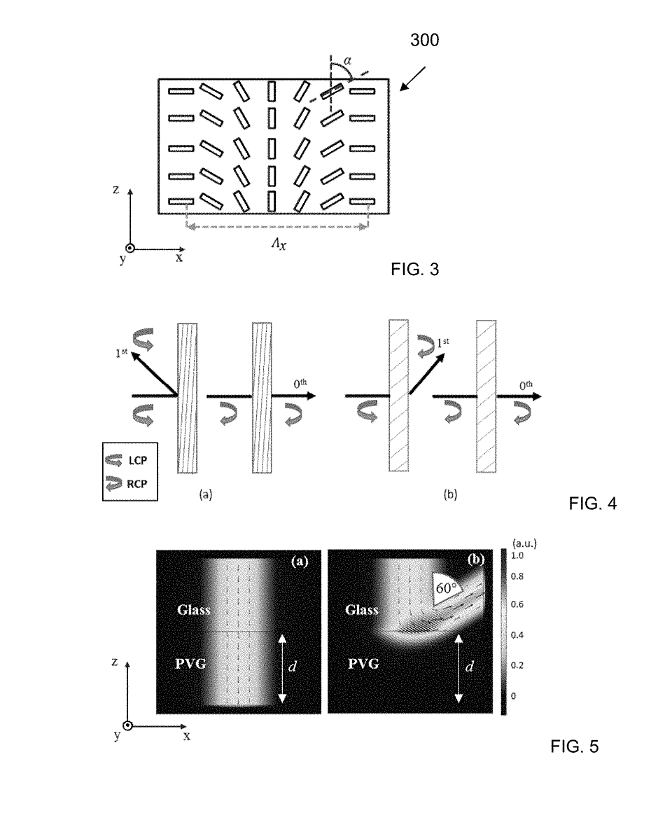

To increase the diffraction angle as embodied herein, a much smaller periodicity along the x-axis (Λₓ) is required. An approach is to use a photo-alignment material to record the interference pattern of two orthogonal, circularly polarized beams so that the structure 300 shown in FIG. 3 can be fabricated. The periodicity Λₓ can be adjusted by changing the angle between the two exposure beams. Compared to mechanical scanning or rotating techniques, the holographic exposure process is much faster and more precise. Although the same exposure setup has reportedly been used in fabricating CDWs, the largest diffraction angles are limited because the physical mechanism involved is a planar phase grating. In contrast, the embodied PVG performs as a volume grating through adding another periodicity, Λ_{y}, perpendicular to the surface 102, which can generate much larger diffraction angles based on Bragg diffraction.

FIGS. 4a and 4b depict the polarization states of diffraction order +1 for the reflective and transmissive VPGs, respectively. Both VPGs can diffract the circularly polarized incident light, which has the same handedness as the helix twist in PVGs (left-handed in FIG. 4). For the reflective PVG (FIG. 4a), the polarization of the first order keeps the same handedness as that of the incident beam. For the transmissive PVG (FIG. 4b), the handedness in the first-order is converted to an orthogonal direction, which is similar to that of the CDW. When the incident beam has an orthogonal handedness to the helical twist of the PVG (right-handed), it will transmit to the 0^{th} order without changing the polarization.

### Modeling of PVG

To investigate the diffractive properties of a PVG, we have built a rigorous model based on FEM using the COMSOL Multiphysics, which is a commercial finite element package.

### Reflective PVG

The simulated results of a reflective PVG illuminated by a left-handed and a right-handed circularly polarized beam at normal incidence are shown in FIGS. 5(a) and 5(b), respectively. In simulation, the period length along the x- and y-directions are set as Λₓ=404.6 nm and Λ_{y}=233.6 nm, which correspond to the slanted angle φ=30° in the PVG. The twist helix in the PVG is right-handed and diffraction with high efficiency can be generated when the incident circularly polarized beam has the same handedness, as shown in FIG. 5(b). In FIG. 5(b) the diffraction angle is 60° in glass (n=1.57) as an illustrated example. In fact, an arbitrary diffraction angle can be obtained by adjusting the periodical length Λₓ or Λ_{y} along x- and y-directions, as outlined below.

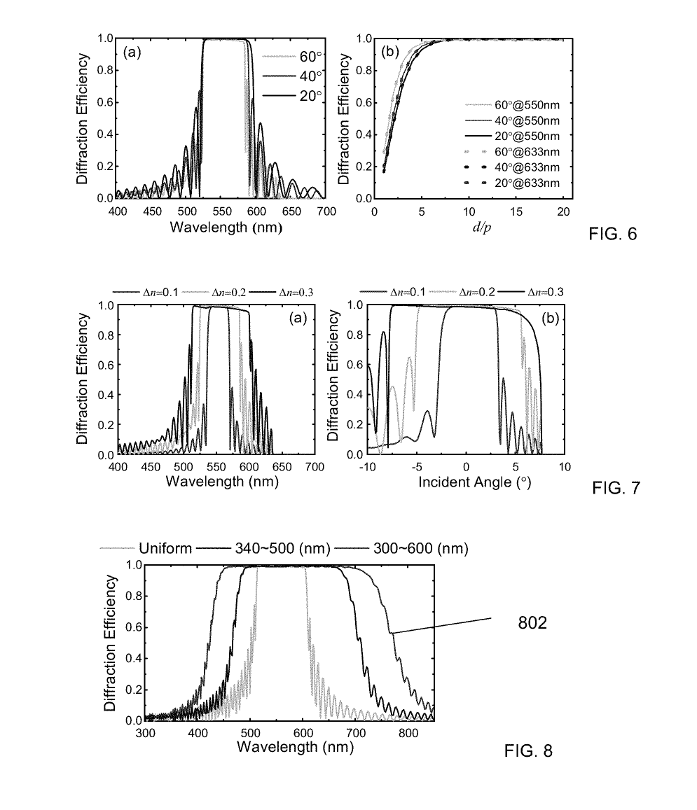

FIG. 6(a) shows the diffraction efficiency spectra at different diffraction angles. From FIG. 6(a), the diffraction efficiency and bandwidth are almost independent of the diffraction angles. This is a very favorable feature, as the PVG can diffract light to different angles with high diffraction efficiency and constant bandwidth. On the other hand, cell gap plays an important role affecting the electro-optic performance of PVGs. To establish Bragg diffraction, the cell gap should be sufficiently thick as referenced above. FIG. 6(b) depicts the thickness requirement for a reflective PVG at different diffraction angles. Because the pitch length varies as the diffraction angle and Bragg wavelength change, here we characterize the thickness properties using d/p, which parameterizes the number of helical pitches in the LC layer. As FIG. 6(b) shows, the diffraction efficiency is insensitive to the operation wavelength A. Therefore, for a certain diffraction angle, the required thickness for achieving high diffraction efficiency can be easily obtained based on the number of pitches. When the value of d/p is over seven (7), diffraction efficiency higher than 98% can be achieved for all conditions in FIG. 6. The corresponding thickness required for the three diffraction angles (20°, 40°, 60° in glass (n=1.57)) is 2.52 μm, 2.8 μm, and 3.29 μm at λ=550 nm, and 2.94 μm, 3.19 μm and 3.73 μm when λ=633 nm. Compared to a conventional volume holographic grating whose thickness is at least tens of micrometers, the thickness of our PVG is much thinner.

The electro-optic performance of PVGs also depends on the birefringence of the employed LC. FIG. 7(a) depicts the efficiency spectra with different Δn's. High birefringence material helps broaden the reflection band, the same as the spectral properties of a CLC. The relationship between the Δn and angular selectivity is also studied and shown in FIG. 7(b). The trend is clear: as Δn increases, the angular band of incident light for achieving high diffraction efficiency becomes broader. This is highly desirable in many applications, such as head-mounted displays. Compared to the refractive index modulation in a HVG, which is usually on the order of 10⁻², the LC birefringence is much higher (e.g., Δn=0.2 is typical). As a result, the PVG has advantages in both diffraction spectra and angular bandwidth over a conventional HVG. Moreover, due to the polarization selectivity of PVGs, high transmission can be achieved for an unpolarized incident beam, which is another important feature for some applications.

In a CLC, the bandwidth of Bragg reflection can be broadened using a gradient pitch length. This approach can also be applied to a reflective PVG, in which a gradient pitch is generated along the y-direction while the periodicity along the x-direction is fixed. The twist angle of the optical axis with gradient pitch length is defined by:

$${α}_{gradient} = \frac{π}{{Λ}_{x}} x + \frac{π}{{Λ}_{y 0}} y + ( \frac{π}{{Λ}_{y 1}} - \frac{π}{{Λ}_{y 0}} ) \frac{{y}^{2}}{2 d} , \qquad ( 6 )$$

where the gradient pitch length increases from 2Λ_{y0} to 2Λ_{y1} within the cell gap d. The diffraction efficiency spectra for the gradient pitch and uniform pitch are depicted in FIG. 8. It is clear that gradient pitch helps broaden the reflection band for a reflective PVG. As the gradient pitch covers a wider range, the reflection band becomes broader (line 802).

### Transmissive PVG

Transmissive diffractive optical elements have been widely used in beam steering and displays. For example, a CDW can diffract light to the ±1^{st} orders based on the handedness of incident circularly polarized light with high diffraction efficiency (>98%). This feature renders CDWs very attractive for the eye-tracking of a virtual reality display. However, the diffraction efficiency decreases dramatically when the diffraction angle (in air) exceeds 15°. The embodied transmission-type PVGs can achieve a much better performance in this regard.

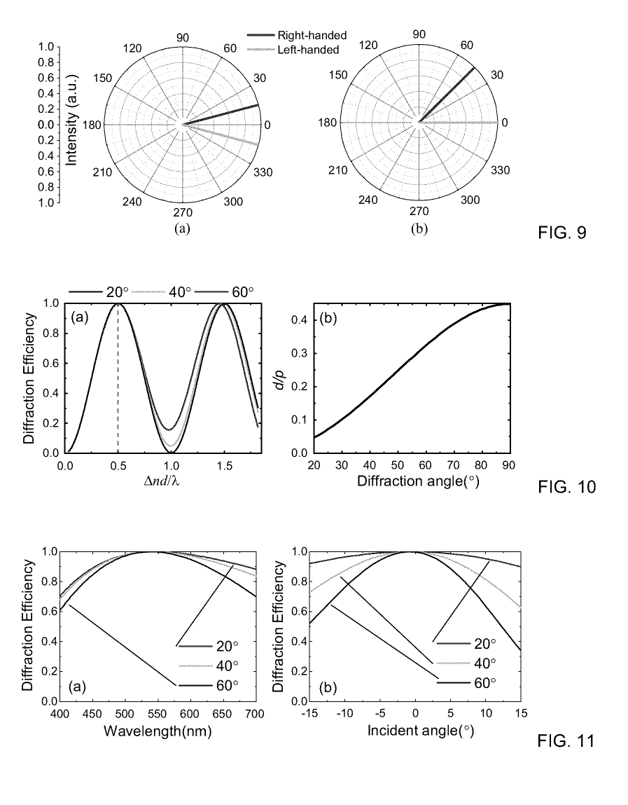

FIGS. 9(a) and 9(b) compare the far-field diffraction intensity patterns between a CDW and a transmissive PVG, respectively. A typical CDW diffracts right- and left-handed circularly polarized incident beams into two orders (±1^{st}) respectively with 15° diffraction angle in air as shown in FIG. 9a. In contrast, for the transmissive PVG, a high efficiency diffraction (+1^{st} or −1^{st} order) occurs only when the circularly polarized incidence has the same handedness as the optical axis rotation in the PVG, and the orthogonal handedness part is transmitted (0^{th} order; FIG. 9b). Compared to CDW, the transmissive PVG exhibits a larger diffraction angle (45° in air).

It is noteworthy that the Fresnel reflection at the air-PVG interface becomes stronger as the diffraction angle increases. For large diffraction angles, an anti-reflection coating can be used to enhance the diffraction efficiency by reducing the reflection at the air-PVG interface. To prevent the Fresnel reflections from affecting the diffraction performance of our PVG, we set a perfectly matched layer (PML, which is an artificial absorbing layer) instead of the air layer in our simulation model and the diffraction angle in air is calculated by Snell's law.

As mentioned above, in order to establish Bragg diffraction for the reflective PVGs, a sufficient number of helical pitches are required. However, for a transmissive PVG, the periodical accumulation for Bragg diffraction is provided mainly along the x-direction due to 45°<φ<90°. As a result, the thickness of the transmissive PVG is thinner than that of the reflective type.

The thickness requirement of a transmissive PVG for different diffraction angles is shown in FIG. 10(a). Here, the incident light is a circularly polarized light with the same handedness as the optical axis rotation in PVG (λ=550 nm, Δn=0.2). From FIG. 10(a), we find that the first maximum diffraction efficiency of the −1^{st} order appears at dΔn/λ≈0.5, i.e., d 1.37 μm for all three specified diffraction angles. Therefore, a large transmission diffraction angle can be generated by adding a small amount of chiral dopants to a typical CDW without changing the thickness. The period length along the x- and y-directions should be adjusted for the desired diffraction angle. When d≈λ/(2Δn), the relation between the values of d/p and diffraction angles is depicted in FIG. 10(b). We note that a longer pitch length p is required when the diffraction angle is small. Meanwhile, considering the unique properties of transmissive PVGs, most of the application scenarios should utilize it as a large diffraction angle grating with high efficiency where the pitch length is in a common range.

To obtain a more comprehensive understanding of the properties of a transmissive PVG, we simulate its diffraction spectra and angular response. Results are plotted in FIGS. 11(a) and 11(b). They show that high diffraction efficiency (˜100%) can be obtained when the Bragg condition is matched (λ=550 nm and incident angle θᵢ=0°). For a larger diffraction angle, say 60°, the wavelength and angular bandwidth of the reflection spectra become narrower.

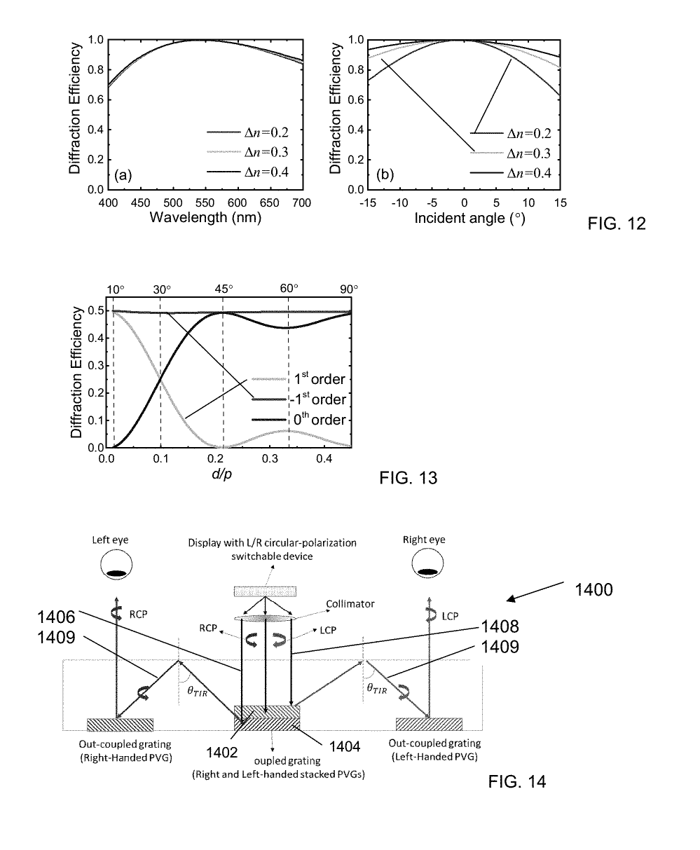

In comparison with reflective PVGs, the diffraction performance of a transmissive PVG is less sensitive to the birefringence. The diffraction spectra and angular sensitivity for different Δn are shown in FIG. 12. It shows that the wavelength band is also insensitive to Δn. On the other hand, as Δn increases the angular band becomes broader. Therefore, a high Δn material is favored when a wide range of incident angle is required.

In the abovementioned simulations, the circularly polarized incidence is assumed to have the same handedness as the optical axis rotation of the birefringent medium. Next, we discuss the diffraction behavior of a transmissive PVG when the incident light has orthogonal handedness to the optical axis rotation.

The CDW diffracts two orthogonal circularly polarized incident beams into +1^{st} and −1^{st} orders respectively. In contrast, the transmissive PVG only diffracts the incident light that has the same handedness as the chiral dopant and transmits another orthogonal handedness without diffraction (0^{th} order; FIGS. 9a, 9b). Thus, there is a significant difference between the CDW and the transmissive PVG. However, the difference gradually disappears as diffraction angle decreases. As discussed earlier, when the diffraction angle decreases, the period length along the y-direction grows (see FIG. 10(b)). An extreme case is when the diffraction angle is 0°, the period length along y direction will be infinity. In this case, no periodicity exists along the y-direction and the transmissive PVG degenerates to a typical CDW.

We investigate the process of degeneration by using linearly polarized incident light, which can be decomposed into two orthogonal circularly polarized beams. With the variation of d/p, the diffraction efficiency for the different orders is depicted in FIG. 13. In simulation, we assumed the thickness d=λ/(2Δn), and the simulation results indicate that only three diffraction orders (0, ±1) are nonzero (>0.01%). In FIG. 13, the diffraction efficiency of the −1^{st} order is independent of d/p (or diffraction angle) and its diffraction efficiency keeps at ˜50%, which corresponds to the diffraction for the half of the incident light having the same handedness as the optical axis in the PVG (right-handed in FIG. 13). For the remaining half (left-handed), the diffraction efficiency is partitioned between −1^{st} and 0^{th} orders, depending on the d/p value. When d/p≈0, the pitch length is near to infinity and the periodicity along the y-direction disappears; as a result, the transmissive PVG degenerates into a typical CDW that diffracts the two orthogonal circularly polarized incident light into +1^{st} and −1^{st} orders, respectively. With increased d/p, diffraction efficiency in +1^{st} decreases rapidly and leaks into the 0^{th} order. The diffraction efficiency of 0^{th} order reaches a maximum (˜50%) when d/p≈0.2 (or diffraction angle≈45° in air), which means all the left-handed circularly polarized beams transmit as the 0^{th} order without diffraction. For d/p>0.2, the diffraction efficiency experiences a slight fluctuation between the +1^{st} and 0^{th} orders as d/p keeps increasing, but the diffraction efficiency in the 0^{th} order remains at a high level and the unique property of the PVG is maintained. The results depicted in FIG. 13 are instructive and the appropriate range of d/p should be adjusted based on the application requirement.

### Exemplary Applications

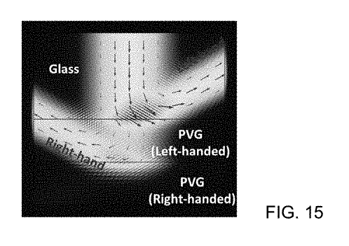

In terms of applications, the embodied PVG can be used in various devices for beam steering, optical switching, and displays. Specifically, a 2D/3D wearable display 1400 using planar waveguides with a reflective PVG is proposed as an example embodiment of this invention. A schematic diagram of the display is shown in FIG. 14, in which two reflective PVGs 1402, 1404, doped with right- and left-handed chiral dopants are stacked as in-coupled gratings. The PVGs diffract right- and left-handed circularly-polarized incident beams 1406, 1408, respectively, and transmit orthogonal circular-polarized beams 1409. Since the handedness of chiral dopants is orthogonal in the two PVGs, the diffractive angles for the two PVGs are +2φ and −2φ for normal incidence based on equation (5), and as long as the diffractive angle is larger than the total internal reflection (TIR) angle θ_{TIR} in the waveguide, the image from the microdisplay will be guided in the waveguide.

FIG. 15 shows the simulation results for the in-coupled stacked PVGs. In a wearable (or head-mounted) display, two reflective PVGs are respectively placed in front of the left and right eyes with a mirror symmetrically positioned as the out-coupled gratings. The two out-coupled gratings diffract the propagating image separately, and break the TIR condition, which sends the output beam to each eye, respectively. With the help of a polarization switchable display, different images can be sent to the left and right eyes respectively and sequentially, which can generate 3D images in a wearable display with only one display panel.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening.

The recitation of ranges of values herein are merely intended to serve as a shorthand method of referring individually to each separate value falling within the range, unless otherwise indicated herein, and each separate value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not impose a limitation on the scope of the invention unless otherwise claimed.

We claim:

1. A polarization volume grating (PVG), comprising:
a bulk, birefringent medium having a top surface and a bottom surface and characterized by a plurality of helical structures with helix axes and a periodicity Λ_{y};
an anisotropic alignment material having a rotatable optical axis, disposed on at least one of the top surface and the bottom surface of the medium,
characterized in that the optical axis of the alignment material has a continuously rotated orientation in a plane of the alignment material surface and a periodicity Λₓ,
wherein the helix axes are normal to the optical axes in the alignment material surface,
wherein the bulk, birefringent medium is further characterized by a plurality of controllably slanted refractive index planes having a slant angle φ=±arctan (Λ_{y}/Λₓ) and a Bragg period Λ_{B}.

2. The PVG of claim 1, wherein the plurality of controllably slanted refractive index planes has a gradient pitch length.

3. The PVG of claim 1, wherein the birefringent material is one of a liquid crystal (LC) and a reactive mesogen.

4. The PVG of claim 1, characterized by a periodically and continuously changing refractive index along two orthogonal directions that are parallel and normal to the alignment substrate.

5. The PVG of claim 1, comprising a reflection PVG.

6. The PVG of claim 1, comprising a transmission PVG.

7. A polarization volume grating (PVG), comprising:
a medium having a periodically and continuously changing refractive index along two orthogonal directions.

8. The PVG of claim 7, wherein the medium has a top and a bottom surface and an intermediate bulk region,
further wherein an optical axis along and in the plane of at least one of the top and bottom surfaces is characterized by a continuous, periodic directional change,
further wherein the bulk medium region is characterized by a tilted, periodic refractive index distribution.

9. The PVG of claim 8, wherein the at least one of the top and bottom surface comprises a photo-alignment material.

10. The PVG of claim 9, wherein the at least one of the top and bottom surface comprises a linear photo-polymerizable polymer (LPP).

11. The PVG of claim 8, wherein the bulk medium region comprises a birefringent material including a plurality of chiral-doped helical structures that are periodic along a helical axis of the chiral-doped medium normal to the top and bottom surfaces.

12. The PVG of claim 11, wherein the bulk medium region comprises a reactive mesogen or a liquid crystal (LC).

13. The PVG of claim 8, wherein the bulk medium region is characterized by a tilted periodic refractive index distribution.

14. The PVG of claim 8, wherein the bulk medium region is characterized by a tilted, gradient, periodic refractive index distribution.

15. A method of making a PVG comprising a bulk, birefringent medium having a top surface and a bottom surface and characterized by a plurality of helical structures with helix axes and a periodicity Λ_{y}; an anisotropic alignment material having a rotatable optical axis, disposed on at least one of the top surface and the bottom surface of the medium, characterized in that the optical axis of the alignment material has a continuously rotated orientation in a plane of the alignment material surface and a periodicity A, wherein the helix axes are normal to the optical axes in the alignment material surface, wherein the bulk, birefringent medium is further characterized by a plurality of controllably slanted refractive index planes having a slant angle φ=±arctan (Λ_{y}/Λₓ) and a Bragg period Λ_{B},
wherein the alignment material having the periodically rotating optical axis is fabricated by one of photo-alignment or physical etching.

16. The method of claim 15, wherein said photo-alignment involves exposing reactive mesogens or other photo-anisotropic media using a beam with constant intensity and spatially varying polarization.

17. The method of claim 16, comprising one of holographic exposure or direct write.

18. The method of claim 17, wherein holographic exposure uses two orthogonal circularly polarized beams, namely left- and right-handed circular polarized beams, that interfere with each other; and the reactive mesogens or other photo-anisotropic medium records an interference pattern.

19. The method of claim 18, comprising adjusting the periodic length of the interference pattern by changing the angle between the two exposure beams.

20. The method of claim 17, wherein the direct-write uses the approach of scanning or rotating techniques through projecting light beams with different linear polarization angles sequentially in space to generate the alignment patterns.

21. The method of claim 15, comprising adjusting the helical pitch by controlling a helical twist power (HTP) or a concentration of a chiral dopant.

22. The method of claim 15, comprising injecting the birefringent material in-between two substrates or spin coated onto the substrate.
